(19) United States
(12) Patent Application Publication
(10) Pub. No.: US 2011/0059723 A1
(43) Pub. Date: Mar. 10, 2011

(54) Mobile Terminal

(75) Inventor: Naoki OGUCHI, Kawasaki (JP)

(73) Assignee: FUJITSU LIMITED, Kawasaki-shi (JP)

(21) Appl. No.: 12/875,421

(22) Filed: Sep. 3, 2010

(30) Foreign Application Priority Data
Sep. 8, 2009 (JP) 2009-207220

(51) Int. Cl. H04W 48/20

(52) U.S. Cl. 455/410

(57) ABSTRACT

A mobile terminal used in a wireless communication system includes a first base station group for which base station information is advertised to the mobile terminal, a second base station group for which the base station information is not advertised to the mobile terminal, the mobile terminal being able to access each base station in the first base station group and a specified base station in the second base station group. The mobile terminal includes a unit to receive location information, and a unit to execute base station detection processing regarding the first base station group and the second base station group when the location information is associated with the specified base station, and to execute the base station detection processing regarding the first base station group while restricting the base station detection processing regarding the second base station group when the location information is not associated with the specified base station.

### CROSS-REFERENCE TO RELATED APPLICATION

This application is based upon and claims the benefit of priority of the prior Japanese Patent Application No. 2009-207220, filed on Sep. 8, 2009, the entire contents of which are incorporated herein by reference.

### FIELD

The present invention relates to a mobile terminal used in a wireless communication system.

### BACKGROUND

In implementation of a worldwide interoperability for microwave access (WiMAX) wireless access network, base stations for public access (referred to as “macro base stations”) are installed. On the other hand, in order to expand communication areas, it has been conceived to place small-size base stations called “femto base stations”. The femto base station is placed, for example, at a place where it is difficult for radio waves to reach. The place where it is difficult for radio waves to reach is, for example, an inside of a house. Hereinafter, the macro base station may be referred to as “public base station”, whereas the femto base station may sometime be referred to as “local base station”.

For example, it is assumed that a femto base station is placed in a home of an individual person in a housing complex. In this case, it is conceivable that access control which is associated with the mobile terminal via the femto base station is performed so as to allow only his/her (individual's) mobile terminal to connect to (access) the femto base station or give a communication to his/her (individual's) terminal the highest priority among communications performed via the femto base station. On the other hand, it is conceivable that handover (HO) is carried out seamlessly from the macro base station to the femto base station, or from the femto base station to the macro base station.

As a method of changing a connected base station under a state keeping communication, the WiMAX system has a handover (HO) mechanism. Specific procedures of the handover are as follows.

(1) The mobile terminal periodically receives a neighbor BS advertisement message (MOB_NBR-ADV message) from a base station to which the mobile terminal is currently communicating (referred to as serving BS (SBS)). With this reception, the terminal may obtain neighbor BS information (connection parameters, such as the center frequency of a neighbor base station, and a preamble index, and HO trigger conditions) regarding a plurality of neighbor BSs.

(2) In association with lowering of the radio field strength of the SBS, the mobile terminal scans for the radio field strengths of neighbor base stations in advance, to thereby search for an optimal base station as a handover destination.

(3) After that, when the radio field strength of the SBS has fallen below a given threshold, the mobile terminal performs negotiation with the SBS, and performs handover to one of the neighbor base stations, which being the handover destination (referred to as target BS (TBS)).

(4) The handover (HO) is carried out in synchronization with the TBS. When the HO is carried out, connection procedures called “network re-entry” are executed between the mobile terminal and the TBS. With these procedures, the mobile terminal may continue the communication through the TBS taking over the connection status with the SBS.

[Patent document 1] Japanese Laid-open Patent Application Publication No. 2008 118404

[Patent document 2] Japanese Laid-open Patent Application Publication No. 2008 219645

The conventional technologies have the following problems.

<1> The neighbor BS advertisement message advertised (broadcast) from a base station has an upper limit for the number of neighbor BSs advertisable. For this reason, for example, in an environment in which a large number of femto BSs exist as neighbor BSs around a given base station, there is a case where the base station cannot notify all the femto BSs in the neighbor BS advertisement message. Specifically, there is a case where a mobile terminal that is permitted to access a given femto base station cannot receive the neighbor BS advertisement message for the femto base station from the SBS, and thus fails to perform handover to the femto base station.

<2> In many cases, a mobile terminal that may access the femto base station is limited to a mobile terminal associated with that femto base station. For this reason, the neighbor BS advertisement message including information about a femto base station is effective only for a mobile terminal that is permitted to access that femto base station, and is useless for another mobile terminal that is not permitted to access that femto base station. In other words, by transmitting the neighbor BS advertisement message for femto base stations to the mobile terminal that is not permitted to access those femto base stations, there is a risk of causing waste of bandwidth and waste of memory space on the mobile terminal.

<3> The format of neighbor base station information to be acquired by the mobile terminal through reception of the neighbor BS advertisement message does not have such a specification that allows a specified mobile terminal to apply information on a specified neighbor base station under a given condition in a limited manner. Accordingly, there is a risk of causing unnecessary operation in which the mobile terminal scans for the radio field strength of a femto base station that the mobile terminal is not permitted to access, tries handover with the femto base station as the TBS, and the handover is refused.

### SUMMARY

According to one aspect of the present invention, there is provided a mobile terminal, which is used in a wireless communication system including:

a first base station group for which information is advertised to the mobile terminal; and

a second base station group for which information is not advertised to the mobile terminal,

the mobile terminal being able to access each base station belonging to the first base station group and a specified base station belonging to the second base station group, the specified base station permitting the mobile station to access,

the mobile terminal including:

a reception unit to receive location information; and

a detection unit to execute base station detection processing with respect to the first base station group and the second base station group when the location information is associated with the specified base station, and to execute the base station detection processing with respect to the first base station group while restricting the base station detection processing with respect to the second base station group when the location information is not associated with the specified base station.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanatory diagram according to a first embodiment;

FIG. 2 illustrates a configuration example of a wireless communication system according to a second embodiment;

FIG. 3 illustrates a configuration example of a base station;

FIG. 4 illustrates a configuration example of a mobile terminal;

FIG. 5 illustrates an example of a neighbor BS information table, a default neighbor BS information table, and a determined neighbor BS information table;

FIG. 6 illustrates an example of an operation sequence in the wireless communication system;

FIG. 7 illustrates a format example of a neighbor BS advertisement message (MOB_NBR-ADV); and

FIG. 8 illustrates a format example of a location information message (MOB_LBS-ADV).

### DESCRIPTION OF THE EMBODIMENT

Hereinafter, with reference to the drawings, embodiments of the present invention are described. The configuration of the embodiments is merely an example, and the present invention is not limited to the configuration of the embodiments. It should be noted that, in the description of the embodiments, a mobile terminal may be referred to as MS (mobile station), whereas a base station may be abbreviated as BS. It should be noted that the mobile terminal may be referred to as mobile station, wireless terminal, portable terminal, terminal, terminal device, wireless terminal device, or portable terminal device.

### First Embodiment

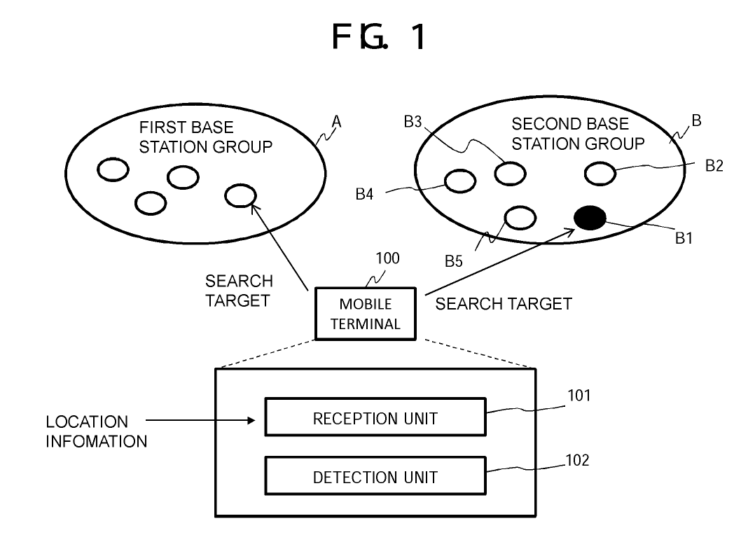

FIG. 1 is an explanatory diagram of a first embodiment. A wireless communication system according to the first embodiment is a wireless communication system including a first base station group A, for which information is advertised to a mobile terminal 100, and a second base station group B, for which information is not advertised to the mobile terminal.

The mobile terminal 100 is permitted to access each of base stations belonging to the first base station group A. On the other hand, with regard to the second base station group B, the mobile terminal 100 is permitted to access a specified base station B1, and is not permitted to access other base stations B2 to B5 than the specified base station B1.

The mobile terminal 100 includes a reception unit 101 that receives location information and a detection unit 102.

In a case where location information received by the reception unit 101 is location information associated with the specified base station B1, the detection unit 102 executes base station detection processing with respect to the first base station group A and the second base station group B. On the other hand, in a case where location information received by the reception unit 101 is not location information associated with the specified base station B1, the detection unit 102 executes the base station detection processing with respect to the first base station group A while restricting the base station detection processing with respect to the second base station group B.

The mobile terminal 100 may have information on one or more base stations (BSs) belonging to the second base station group B in advance, which is associated with location information. Based on location information acquired by the reception unit 101, the mobile terminal 100 may select a detection target base station from the second base station group B. In a case where there is no information of the second base station group B, which is associated with the location information, the base station detection processing with respect to the second base station group B may be restricted. For example, the mobile terminal 100 may set, as targets of the base station detection processing, a base station contained in neighbor base station information that is advertised from a currently-connected base station, and a base station selected based on the location information. Note that each of the reception unit 101 and the detection unit 102 may be configured by dedicated or general-purpose hardware (e.g., one or more electronic circuits). The detection unit may be realized by a non-transitory computer-readable medium (e.g., memory or storage) storing executable instructions (included in a computer program) and a processor, such as a central processing unit (micro processing unit) or a digital signal processor, executing the executable instructions causing the processor to operate as the detection unit.

As the location information, location information of the mobile terminal, which is acquired from the currently-connected base station, may be applied. Alternatively, as the location information, location information of base stations, which is acquired from the currently-connected base station, may be applied. Alternatively, as the location information, location information of the mobile terminal, which is acquired from a global positioning system (GPS) satellite, may be applied.

According to the first embodiment, the mobile terminal 100 can control, based on the location information, whether to set a base station belonging to the second base station group as a target of the base station detection processing. In other words, the mobile terminal 100 can appropriately detect a base station having access restriction based on the location information.

### Second Embodiment

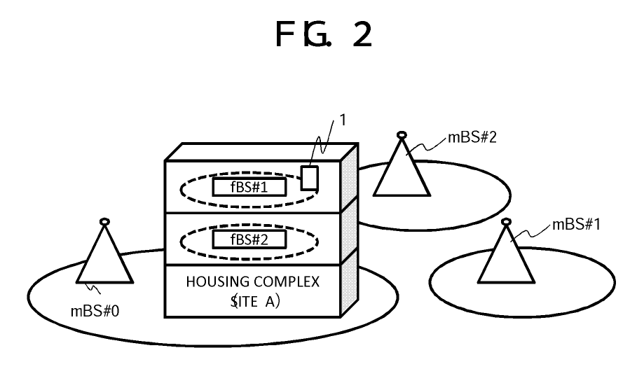

FIG. 2 is a diagram illustrating a network configuration example according to a second embodiment. A wireless communication system illustrated in FIG. 2 is a worldwide interoperability for microwave access (WiMAX) system, and it is assumed that a base station (BS) and a mobile terminal (MS) perform communication according to the IEEE 802.16e-2005 standard or later.

In FIG. 2, there is a housing complex (apartment building) at a site A. Around the housing complex, as examples of macro BSs (hereinafter, referred to as “mBSs”) serving as a plurality of public base stations, there are installed three mBSs, that is, an mBS#0, an mBS#1, and an mBS#2.

The mBS#0 has “0x0” as a BS identifier (BSID). The mBS#0 sends a signal (radio wave) at a center frequency f0. The radio wave sent from the mBS#0 contains a value indicating “preamble index=a” as frame identification information for identifying a frame transmitted from the mBS#0.

The mBS#1 has a BSID “0x1”. The mBS#1 sends a signal (radio wave) at a center frequency f1. The radio wave sent from the mBS#1 contains a value indicating “preamble index=b” as the frame identification information for identifying a frame transmitted from the mBS#1.

The mBS#2 has a BSID “0x2”. The mBS#2 sends a signal (radio wave) at a center frequency f2. The radio wave sent from the mBS#2 contains a value indicating “preamble index=c” as the frame identification information for identifying a frame transmitted from the mBS#2.

Inside the housing complex, as examples of femto base stations (hereinafter, referred to as “fBSs”) serving as a plurality of local base stations, an fBS#1 and an fBS#2 are illustrated. The fBS#1 has a BSID “0x10001”. The fBS#1 sends a signal (radio wave) at a center frequency f3. The radio wave sent from the fBS#1 contains a value indicating “preamble index=d” as the frame identification information for identifying a frame transmitted from the fBS#1. The fBS#2 has a BSID “0x10002”. The fBS#2 sends a signal (radio wave) at a center frequency f4. The radio wave sent from the fBS#2 contains a value indicating “preamble index=e” as the frame identification information for identifying a frame transmitted from the fBS#2.

A mobile terminal (MS) 1 is a terminal device capable of wireless communication using a WiMAX network. In a coverage area (also referred to as radio wave area) of an mBS, the mobile terminal 1 can connect to the mBS and perform communication. In a coverage area of an fBS, the mobile terminal 1 can connect to the fBS and perform communication only in a case where the mobile terminal 1 is permitted to access the fBS, that is, in a case where the use of the fBS is permitted.

Accordingly, in a case where the mobile terminal 1 moves across coverage areas of mBSs, the mobile terminal 1 can continue communication by means of handover between the mBSs. Further, in a case where the mobile terminal 1 moves from the coverage area of an fBS that the mobile terminal 1 is permitted to use to the coverage area of an mBS, the mobile terminal 1 can continue communication by means of handover between the fBS and the mBS. On the other hand, in a case where the mobile terminal 1 moves from the coverage area of an mBS to the coverage area of an fBS that the mobile terminal 1 is not permitted to use, handover between the mBS and the fBS is not carried out, and hence the mobile terminal 1 cannot continue communication.

<Configuration of Base Station>

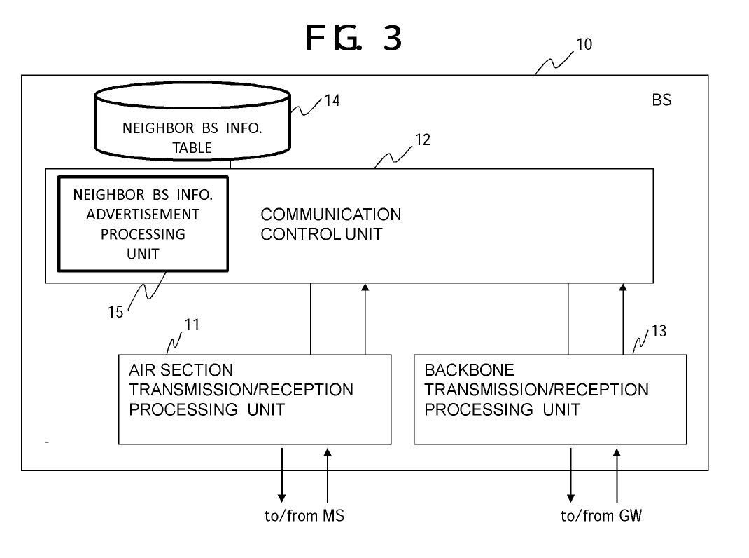

FIG. 3 illustrates a configuration example of a base station (BS). A base station 10 illustrated in FIG. 3 is applicable as the mBS or the fBS illustrated in FIG. 2. In FIG. 3, the base station 10 includes an air section transmission/reception processing unit 11, a communication control unit 12, a backbone transmission/reception processing unit 13, and a neighbor BS information table 14. Further, the communication control unit 12 includes a neighbor BS information advertisement processing unit 15.

The air section transmission/reception processing unit 11 converts various messages to be transmitted to the mobile terminal (MS) into radio waves, and then transmits the radio waves to the mobile terminal. Further, the air section transmission/reception processing unit 11 extracts messages from radio waves received from the mobile terminal, and then passes the messages to a processing unit that processes the messages, such as the communication control unit 12.

The communication control unit 12 exchanges a control message with a gateway device (GW: not shown), which is a managing device of the base station, and the mobile terminal, to thereby maintain and control communication of the mobile terminal. The communication control unit 12 transmits a message to the air section transmission/reception processing unit 11. In another case, the communication control unit 12 receives, from the air section transmission/reception processing unit 11, a control message transmitted from the mobile terminal. Further, the communication control unit 12 performs communication with the gateway device via the backbone transmission/reception unit 13.

The backbone transmission/reception unit 13 is connected to a backbone network (not shown), and the backbone network accommodates the gateway devices (GWs) and other base stations. The backbone transmission/reception unit 13 performs transmission/reception processing so that the base station 10 exchanges a message with other base stations via the backbone network.

The neighbor BS information table 14 is a table for managing information on neighbor base stations (also referred to as “neighbor BSs”), which is advertised by the base station 10 to the mobile terminal with the use of a neighbor BS advertisement message, for each version of the neighbor BS advertisement message. Note that each of the air section transmission/reception processing unit 11, the communication control unit 12, the backbone transmission/reception unit 13, and the neighbor BS information processing unit 14 may be configured by dedicated or general-purpose hardware (e.g., one or more electronic circuits). At least one of these units 11, 12, 13 and 14 may be realized by a computer-readable medium (e.g., memory or storage) storing executable instructions (included in a computer program) and a processor, such as a central processing unit (micro processing unit) or a digital signal processor, executing the executable instructions causing the processor to operate as at least one of the units 11, 12, 13 and 14. The neighbor BS information table is generated and stored on the computer-readable medium such as the memory or the storage.

In accordance with an instruction issued from the gateway device, the neighbor BS information advertisement processing unit 15 creates a neighbor BS advertisement message containing information on neighbor base stations for the mobile terminal, and then transmits the neighbor BS advertisement message to the mobile terminal via the air section transmission/reception processing unit 11. In the second embodiment, the neighbor BS advertisement message contains, as neighbor base station information, only information on mBSs and does not contain information on fBSs. Accordingly, information on fBSs is not advertised by means of the neighbor BS advertisement message.

<Configuration of Mobile Terminal>

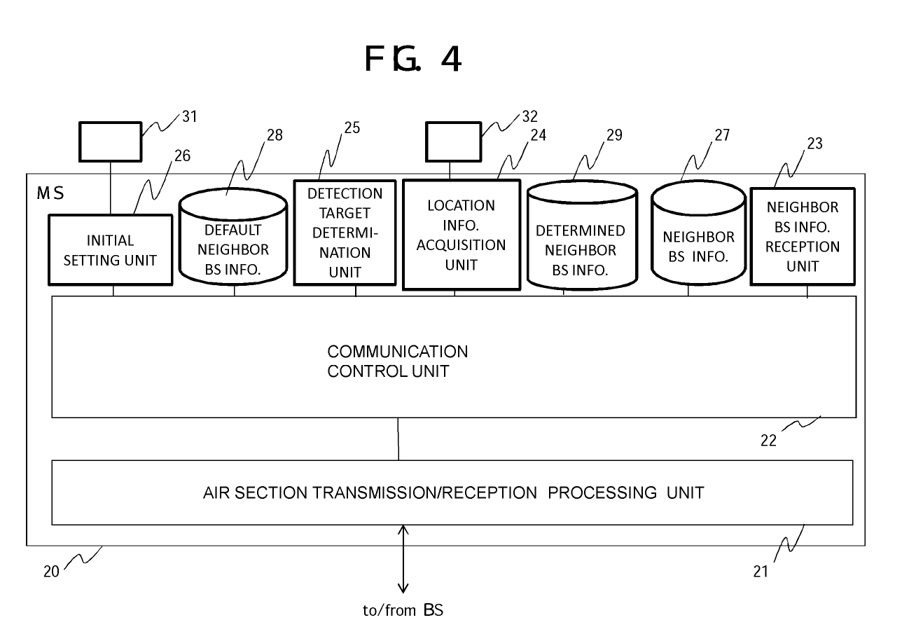

FIG. 4 illustrates a configuration example of a mobile terminal (MS). A mobile terminal 20 illustrated in FIG. 4 is applicable as the mobile terminal 1 illustrated in FIG. 2. The mobile terminal 20 includes an air section transmission/reception processing unit 21, a communication control unit 22, a neighbor BS information reception unit 23, a location information acquisition unit 24 as a reception unit, a detection target determination unit 25 as a detection unit, and an initial setting unit 26.

Further, the mobile terminal 20 includes a neighbor BS information table 27, a default neighbor BS information table 28, and a determined neighbor BS information table 29. Further, the mobile terminal 20 includes a console 31 connected to the initial setting unit 26 and a GPS receiver 32 connected to the location information acquisition unit 24.

The air section transmission/reception processing unit 21 achieves synchronization with a frame transmitted from a base station specified as a connection target, or a base station for which scan is determined to be performed based on the determined neighbor BS information table 29 or the like, and then performs transmission and reception of the frame.

The communication control unit 22 exchanges a control message with the base station, to thereby maintain and control communication performed with the base station. The communication control unit 22 transmits a message to the air section transmission/reception processing unit 21. In another case, the communication control unit 22 receives, from the air section transmission/reception processing unit 21, a control message issued from the base station.

The neighbor BS information reception unit 23 receives a neighbor BS advertisement message containing neighbor base station information, which is transmitted by the base station, and registers the contents of the neighbor base station information in the neighbor BS information table 27.

The location information acquisition unit 24 receives a location information signal transmitted by the base station. Alternatively, the location information acquisition unit 24 may acquire the location information of the mobile terminal 20 with the use of the GPS receiver 32 included in the mobile terminal 20.

The detection target determination unit 25 selects, from the default neighbor BS information table 28, an fBS associated with the location information acquired by the mobile terminal 20 with the use of the location information acquisition unit 24, and then registers the selected fBS in the determined neighbor BS information table 29 along with neighbor base stations recorded (registered) in the neighbor BS information table 27.

The initial setting unit 26 receives information that is input from the console 31 including a display device and an input device, or information that is downloaded from a network, and performs processing of creating the default neighbor BS information table 28.

The neighbor BS information table 27 is a table for registering the content of an advertisement message containing information on neighbor base stations, which is received from the base station.

The default neighbor BS information table 28 is a table for registering information on an fBS that is to be mapped based on the location information, and is created by the initial setting unit 26.

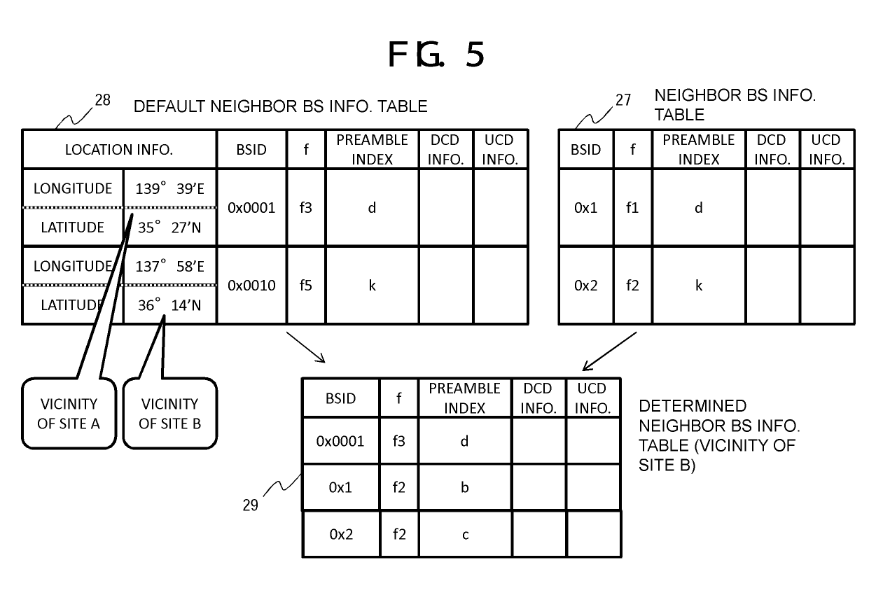

The determined neighbor BS information table 29 is a table for registering information necessary for detecting a final detection target base station, which is determined by the detection target determination unit 25 from among base stations registered in the neighbor BS information table 27 and the default neighbor BS information table 28. FIG. 5 illustrates a data structure example of the neighbor BS information table 27, the default neighbor BS information table 28, and the determined neighbor BS information table 29. In FIG. 5, the neighbor BS information table 27 stores, for each neighbor base station, a BS identifier (BSID), a center frequency, frame identification information (preamble index value), downlink channel descriptor (DCD) information, and uplink channel descriptor (UCD) information. The DCD information is information regarding a downlink channel, whereas the UCD information is information regarding an uplink channel. The default neighbor BS information table 28 stores, for each neighbor BS, a location condition, a BSID, a center frequency, a preamble index value, DCD information, and UCD information. Further, similarly to the neighbor BS information table 27, the determined neighbor BS information table 29 stores, for each neighbor base station, a BSID, a center frequency, a preamble index value, DCD information, and UCD information. Note that each of the air section transmission/reception processing unit 21, the communication control unit 22, the neighbor BS information reception unit 23, the location information acquisition unit 24, The detection target determination unit 25, the initial setting unit 26 may be configured by dedicated or general-purpose hardware (e.g., one or more electronic circuits). At least one of these units 21-26 may be realized by a computer-readable medium (e.g., memory or storage) storing executable instructions (included in a computer program) and a processor, such as a central processing unit (micro processing unit) or a digital signal processor, executing the executable instructions causing the processor to operate as at least one of the units 21-26. The tables 27, 28 and 29 are generated and stored on the computer-readable medium such as the memory or the storage.

### Operation Example

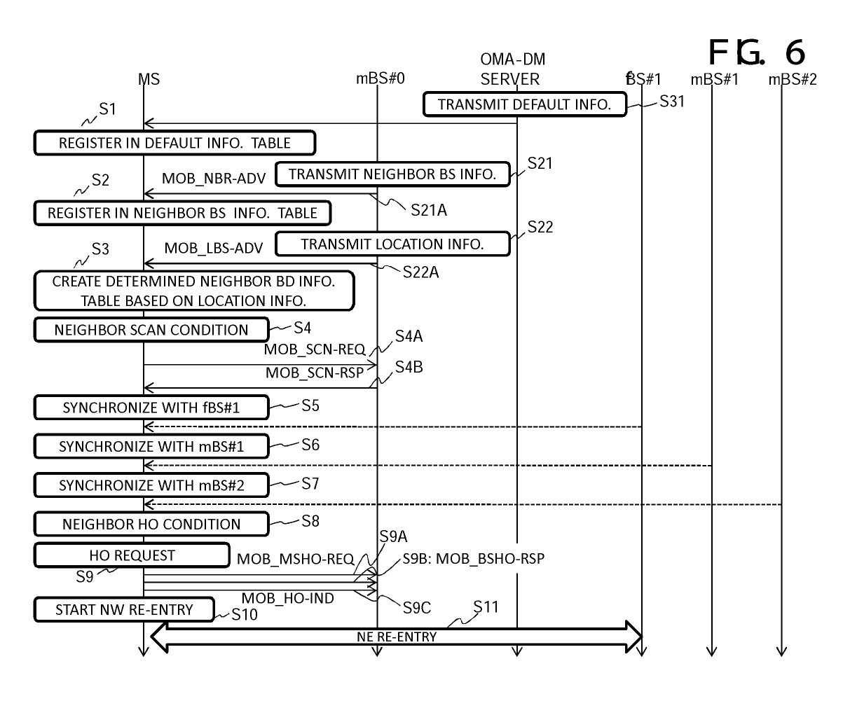

Hereinafter, operation according to this embodiment is described with reference to a sequence diagram (FIG. 6) corresponding to movement of the mobile terminal 1 illustrated in FIG. 2. In an operation example illustrated in FIG. 2, it is assumed that the mobile terminal 1 is performing communication outside the housing complex with the mBS#0 as an SBS. Description is given of operation performed in a case where, after that, the mobile terminal 1 moves into the housing complex located at the site A, thereby moving from the coverage area of the mBS#0 to the coverage area of the fBS#1.

FIG. 6 illustrates an operation sequence. The fBS#1 (FIG. 2) indicated in FIG. 6 is managed by a user of the mobile terminal 1, and is placed in the housing complex in the vicinity of the site A (139 degrees 39 minutes east longitude, 35 degrees 27 minutes north latitude). A BSID “0x0001”, a center frequency “f3”, and a preamble index value “d” are assigned to the fBS#1 by a carrier. Those pieces of information are set by the carrier at the time of installing the fBS#1, for example.

Further, the user of the mobile terminal 1 owns a vacation home in the vicinity of a site B (137 degrees 58 minutes east longitude, 36 degrees 14 minutes north latitude), and, in the vacation home, an fBS#3 managed by the user is placed. The fBS#3 has a BSID “0x0010”, a center frequency “f5”, and a preamble index value “k”, which are assigned by the carrier.

First, in the mobile terminal 1, the initial setting unit 26 (FIG. 4) performs registration processing for the default neighbor BS information table 28. The default neighbor BS information table 28 is a table that associates information on an fBS managed by the user of the mobile terminal 1 with a location condition for the fBS to be registered as a neighbor BS.

As the location condition, location information of the vicinity of the site at which the fBS is placed is registered in the default neighbor BS information table 28. For example, as for the fBS#1, location information of the vicinity of the site A is registered.

As the location information of the vicinity of the site A, the location information of the mobile terminal 1 itself existing in the vicinity of the site A may be applied. Alternatively, the location information of an mBS, which is provided by the mBS to which the mobile terminal 1 is connected in the vicinity of the site A, may be applied as the location information of the vicinity of the site A. Alternatively, location information of the site A, which is downloadable onto the mobile terminal 1 from a network, may be applied as the location information of the vicinity of the site A.

In the case of using the location information of the mobile terminal 1, for example, when the mobile terminal 1 is located in the vicinity of the site A, the location information acquisition unit 24 acquires the location information of the mobile terminal 1 itself, which is received from a GPS satellite with the use of the GPS receiver 32, and hence the initial setting unit 26 of the mobile terminal 1 can register the location information in the default neighbor BS information table 28.

In the case of using the location information of the base station, when the mobile terminal 1 is connected to an mBS in the vicinity of the site A, the initial setting unit 26 of the mobile terminal 1 acquires the location information of the mBS, which is received from the mBS, and thus can register the location information in the default neighbor BS information table 28.

In the case of using the location information downloaded from a network, the initial setting unit 26 of the mobile terminal 1 downloads the location information of the site A or the vicinity of the site A from a computer or a server which exists on the network and is capable of providing the location information, and thus can register the location information in the default neighbor BS information table 28. The computer or the server is, for example, an open mobile alliance-device management (OMA-DM) server. The OMA-DM has been developed by the Open Mobile Alliance, and is a standard specification for an open and interoperable device management protocol.

Further, as a method of registering the location condition, the initial setting unit 26 may register, in the default neighbor BS information table 28, location information that has been input to the mobile terminal 1 through manual operation performed on the console 31.

The initial setting unit 26 may register, in the default neighbor BS information table 28, information on an fBS which is input through manual operation performed on the console 31. Alternatively, the initial setting unit 26 may download information on an fBS from a network, to thereby register the information in the default neighbor BS information table 28.

For example, in a case of manually registering a location condition and fBS information, the location condition, the BSID, the center frequency (Frequency), the preamble index value, the DCD information, and the UCD information are input from the console 31. The initial setting unit 26 registers those pieces of information in the default neighbor BS information table 28.

Alternatively, the OMA-DM server may be used so that the location condition and the fBS information provided from the network are automatically registered in the default neighbor BS information table 28. For example, at the time of initial registration of the mobile terminal 1 or when an fBS owned by the user of the mobile terminal 1 has been added, the initial setting unit 26 is connected to the OMA-DM server, and the OMA-DM server transmits registration contents for the default neighbor BS information table 28 to the mobile terminal 1. Then, the initial setting unit 26 registers the received registration contents in the default neighbor BS information table 28.

In FIG. 6, the OMA-DM server transmits, to the mobile terminal 1, registration contents regarding the fBS#1 and the fBS#3, that is, information on the fBS#1 and a location condition thereof and information on the fBS#3 and a location condition thereof (S31). Then, the initial setting unit 26 of the mobile terminal 1 registers the received registration contents in the default neighbor BS information table 28 (S1).

Here, the mobile terminal 1 is connected to the mBS#0 (FIG. 2), and is performing communication therewith. The mBS#0 periodically performs processing of transmitting a neighbor BS advertisement message generated by the neighbor BS information advertisement processing unit 15 (FIG. 4) (S21), to thereby advertise (broadcast) the neighbor BS advertisement message via the air section transmission/reception processing unit 11 within the coverage area of the mBS#0.

Owing to this, the neighbor BS advertisement message is transmitted to the mobile terminal 1 located in the coverage area of the mBS#0 (S21A). The neighbor BS advertisement message from the mBS#0 contains information on the mBS#1 and the mBS#2 as the neighbor BS information. It should be noted that the neighbor BS advertisement message does not contain information on an fBS.

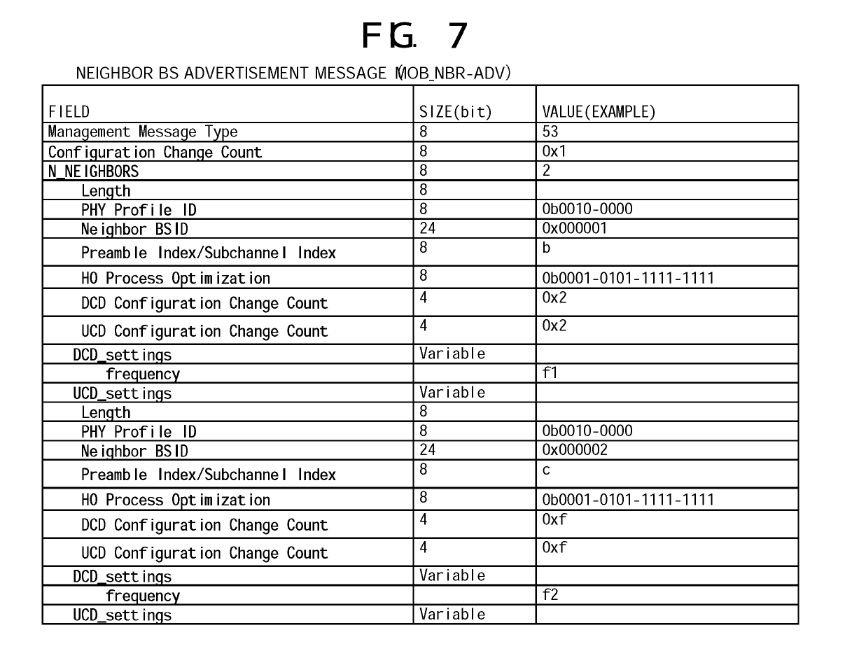

FIG. 7 illustrates a format of the neighbor BS advertisement message (MOB_NBR-ADV message) for advertising neighbor base stations. Hereinafter, description is given of the fields of the MOB_NBR-ADV message in accordance with IEEE 802.16e.

In FIG. 7, a “Management Message Type” field represents a message type indicating the MOB_NBR-ADV message, which is defined as “0x53” in the IEEE 802.16e-2005.

A “Configuration Change Count” field indicates a version number of the neighbor BS advertisement message itself shared between the base station and the mobile terminal. In a case when the mobile terminal designates a base station contained in the neighbor BS advertisement message, the mobile terminal specifies the “Configuration Change Count” and the order (index) of the neighbor BS described in the neighbor BS advertisement message with respect to the base station.

An “N_NEIGHBORS” field indicates the number of neighbor BSs contained in the neighbor BS advertisement message.

A “Length” field indicates a total sum in size of information elements regarding one neighbor BS in a FOR loop.

A “PHY Profile ID” field relates to a parameter indicating whether or not various kinds of settings of the neighbor BS are the same as the settings of the SBS. As for information having the same setting contents as the SBS according to the “PHY Profile ID”, the information is not carried on the neighbor BS advertisement message, and, instead, the mobile terminal copies parameters of the SBS and uses the parameters.

A “Neighbor BSID” field indicates a BS identification number allocated to the neighbor BS.

A “Preamble Index/Subchannel Index” field represents an index for indicating an identification code embedded, for BS discrimination, in a preamble part of a signal transmitted by the neighbor BS or a repeater.

An “HO Process Optimization” field indicates processing that is omissible in network re-entry procedures. In a case of performing handover to a neighbor BS, the network re-entry procedures are requested. By transferring connection information of the mobile terminal from the SBS to the neighbor BS, some of the network re-entry procedures may be omitted. The “HO Process Optimization” field represents information indicating omissible processing. Based on information described in the “HO Process Optimization”, the mobile terminal can select, as a handover candidate, a BS with which the re-entry procedures are finished in as short a time period as possible.

A “DCD Configuration Change Count” field indicates a version number of a DCD message transmitted by a neighbor BS. The NBR-ADV message contains a content of the DCD message periodically transmitted by the neighbor BS as “DCD_setting”.

A “UCD Configuration Change Count” field indicates a version number of a UCD message transmitted by a neighbor BS. The NBR-ADV message contains a content of the UCD message periodically transmitted by the neighbor BS as “UCD_setting”.

The “DCD_settings” field indicates the following information. The NBR_ADV message contains a content of the DCD message periodically transmitted by a neighbor BS as “DCD_setting”. The “DCD_setting” is information in compound TLV (Type-Length-Value) format, which is structured by a plurality of pieces of information in TLV format. Various kinds of TLVs in the DCD message transmitted by a neighbor BS are collectively stored in “DCD_setting TLV”. It should be noted that only TLVs different from those of the DCD of the SBS are contained.

A “frequency” field is a sub-TLV contained in the “DCD_settings TLV”. The “frequency” field indicates the center frequency of a neighbor BS. In a case where the center frequency is the same as the frequency of the SBS, the “frequency” field may be omitted.

The “UCD_settings” field is the following information. The NBR_ADV message (neighbor BS advertisement message) contains a content of the UCD message periodically transmitted by a neighbor BS as “UCD_setting”. The “UCD_setting” is compound TLV information, which is structured by a plurality of pieces of TLV information. Various kinds of pieces of TLV information in the UCD message transmitted by a neighbor BS are collectively stored in “UCD_setting TLV”. It should be noted that only pieces of TLV information different from those of the UCD of the SBS are contained.

It should be noted that information of at least the DCD Configuration Change Count” field and the “DCD_settings” field is registered in the neighbor BS information table 27 as the DCD information. On the other hand, information of at least the “UCD Configuration Change Count” field and the “UCD_settings” field is registered in the neighbor BS information table 27 as the UCD information.

The neighbor BS information reception unit 23 of the mobile terminal 1 receives the neighbor BS advertisement message (MOB_NBR-ADV message) via the air section transmission/reception processing unit 21 and the communication control unit 22, and then registers various pieces of information contained in the neighbor BS advertisement message in the neighbor BS information table 27 (S2). With this, an entry corresponding to the mBS#1 and an entry corresponding to the mBS#2, which are neighbor base stations of the mBS#0, are registered in the neighbor BS information table 27.

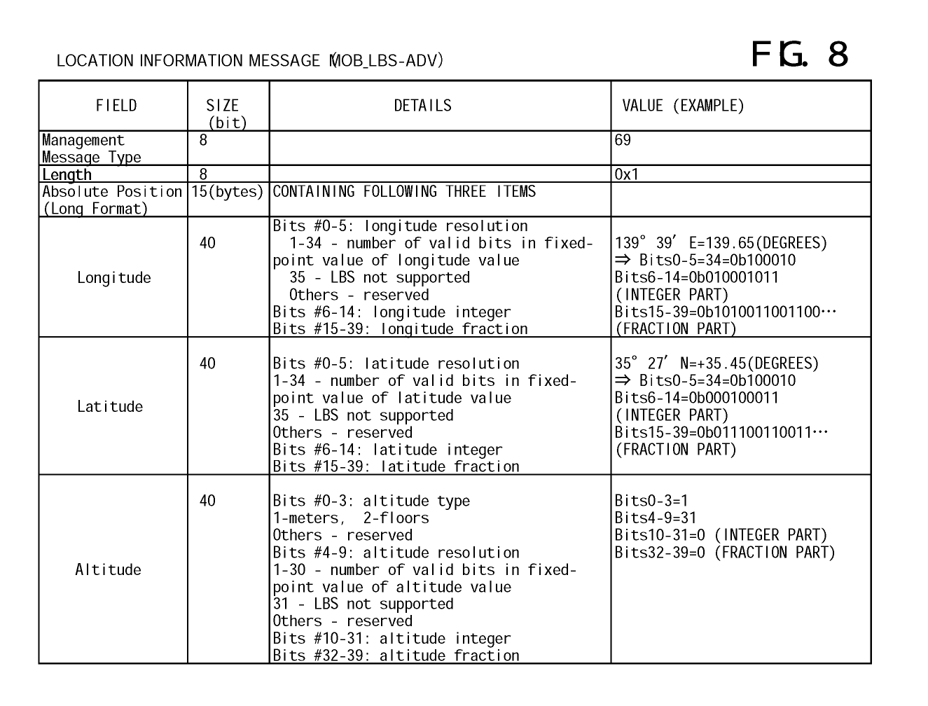

Further, the communication control unit 12 of the mBS#0 periodically performs processing of transmitting a location information (location advertisement) message (MOB_LBS-ADV message) (S22), to thereby transmit the location information message to the coverage area of the mBS#0 (S22A). The location information message contains the location information of the mBS#0. FIG. 8 illustrates a format of the MOB_LBS-ADV message.

The MOB_LBS-ADV message contains a “Management Message Type” field, which indicates a message type, a “Length” field, which indicates a size of information elements, and an “Absolute Position” field, which indicates a location of the base station. The “Absolute Position” field contains a “Longitude” field, a “Latitude” field, and an “Altitude” field.

The mobile terminal 1 receives the location information message with the use of the air section transmission/reception processing unit 21. The location information message is provided to the location information acquisition unit 24 via the communication control unit 22. The location information acquisition unit 24 passes the location information of the mBS#0 which is contained in the location information message to the detection target determination unit 25.

The detection target determination unit 25 refers to the default neighbor BS information table 28. Then, in a case where there is an fBS that satisfies the location condition, that is, an fBS whose location information satisfies the location condition (in this case, fBS#1), the detection target determination unit 25 registers, in the determined neighbor BS information table 29, an entry regarding the fBS#1, and the entry of the mBS#1 and the entry of the mBS#2 which are currently registered in the neighbor BS information table (S3).

With this, there is obtained a state in which, as neighbor base stations to be subjected to the base station detection processing (scan processing) for handover, the mBS#1, the mBS#2, and the fBS#1 are registered in the determined neighbor BS information table 29. Here, in a strict sense, the location of the mBS#0 differs from the location of the fBS#1. However, the default neighbor BS information table 28 is created (set) so that, when the mobile terminal 1 is located in the vicinity of the location of the mBS#0, the fBS#1 becomes a target of scan.

In the operation described above, there has been given the example in which the mobile terminal 1 judges whether or not the location condition is satisfied based on the location information of the mBS#0 itself. Instead of the example described above, the location information of the fBS#1 may be received and registered. In the location information message (MOB_LBS-ADV) transmitted from the mBS#0, the location information of a neighbor BS may be described. Therefore, the mobile terminal 1 can acquire the location information of the fBS#1 from the mBS#0 if the BSID of the fBS#1 is specified in the message and can use it for judging.

In this case a network bandwidth is wasted because extra location information of the fBS#1 is contained in the location information message. However, the drawback may be reduced compared with a case where base station information on an fBS is contained in the neighbor BS information advertisement message (MOB_NBR-ADV). Alternatively, as the location information, for example, the location information of the mobile terminal 1, which is acquired from a GPS satellite by the GPS receiver 32, may be used to judge whether or not the location condition is satisfied.

In the mobile terminal 1, when the radio field intensity of the currently-connected SBS, that is, the mBS#0, has declined, and a trigger condition for starting neighbor BS scan is satisfied (S4), the communication control unit 22 determines, as scan targets, the neighbor base stations registered in the determined neighbor BS information table, that is, the mBS#1, the mBS#2, and the fBS#1, and then performs scan for the frequencies of those neighbor base stations.

Specifically, the communication control unit 22 of the mobile terminal 1 transmits a scan request message “MOB_SCN-REQ” (S4A), to thereby make a request for a scan time to the SBS (mBS#0). The mobile terminal 1 receives a scan response message “MOB_SCN-RSP” from the mBS#0 serving as the SBS (S4B). After the scan time is allocated from the SBS by means of the scan response message, procedures up to preamble synchronization are carried out, and it is confirmed which base station is available for synchronization at which frequency. It should be noted that the SBS stops packet transmission to the mobile terminal 1 during the scan time.

In this example, the mobile terminal 1 achieves synchronization at the frequency f3, the frequency f1, and the frequency f2, and, at the frequency f3, discovers the preamble index “d” of the fBS#1, thereby achieving the preamble synchronization with the fBS#1. After achieving the synchronization with the fBS#1, the mobile terminal 1 scans for the radio field intensity of the fBS#1 (S5).

Further, at the frequency f1, the mobile terminal 1 discovers the preamble index “b” of the mBS#1, thereby achieving the preamble synchronization with the mBS#1. At this time, the mobile terminal 1 scans for the radio field intensity of the mBS#1 (S6).

Further, at the frequency f2, the mobile terminal 1 discovers the preamble index “c” of the mBS#2, thereby achieving the preamble synchronization with the mBS#2. At this time, the mobile terminal 1 scans for the radio field intensity of the mBS#2 (S7).

Here, it is assumed that, of the radio field intensities of the fBS#1, the mBS#1, and the mBS#2 which are scanned for by the mobile terminal 1, the radio field intensity of the fBS#1 is the strongest. After that, when the radio field intensity of the mBS#0 serving as the SBS has declined, and the radio field intensity of the fBS#1 has become satisfactory, satisfying a trigger condition for handover (HO) (S8), the mobile terminal 1 starts handover with the fBS#1 as a target base station (TBS) (S9).

Specifically, the mobile terminal 1 transmits a mobile terminal handover request message “MOB_MSHO-REQ” (S9A), to thereby make a request for handover to the mBS#0 serving as the SBS. The mobile terminal 1 receives a base station handover response message “MOB_BSHO-RSP” from the mBS#0 (S9B), and obtains a response indicating that handover is possible. Then, the mobile terminal 1 transmits a handover indication message “MOB_HO-IND” (S9C), to thereby notify the mBS#0 of a neighbor BS serving as the TBS, that is, the fBS#1.

After that, upon synchronization with the fBS#1, the mobile terminal 1 starts registration procedures called “network re-entry” (S10), and carries out network re-entry procedures with the fBS#1 (S11). After the network entry is finished, the mobile terminal 1 resumes communication with the fBS#1 as a new SBS. It should be noted that the DCD information and the UCD information of the fBS#1, which are registered in the determined neighbor BS information table 29, are used in handover procedures.

Here, in the operation example described above, there has been given the description of the case where the SBS is an mBS, but similar operation as in the case described above is performed also in a case where the SBS is an fBS.

<Operation and Effect of Embodiment>

According to the embodiment described above, with respect to the default neighbor BS information table 28, which is a first table of the mobile terminal 1, the initial setting unit 26 registers information on an fBS available for the mobile terminal 1 along with the location condition indicating the location of the fBS.

On the other hand, the neighbor BS information reception unit 23 registers information on a neighbor BS of the SBS in the neighbor BS information table 27, which is a second table. Further, the location information acquisition unit 24 serves as the reception unit to acquire the location information of the SBS.

Then, the detection target determination unit 25 serves as the detection unit to compare the location information of the SBS and the location condition of the default neighbor BS information table 28, and information on an fBS that satisfies the location condition is registered in the determined neighbor BS information table 29, which is a third table, along with the information on the mBS in the neighbor BS information table 27. Specifically, the fBS#1 is contained as a target of the scan processing, which is the base station detection processing, and the mBS and the fBS registered in the determined neighbor BS information table 29 are determined as scan target BSs at the time of handover from the SBS. After that, when the radio field intensity of the SBS has declined, and the radio field intensity of the fBS satisfies the trigger condition for handover, handover is carried out from the SBS to the fBS serving as the TBS.

On the other hand, in a case where the location information does not satisfy the location condition, the information on the fBS is not registered in the determined neighbor BS information table 29, preventing the fBS from becoming the target of the scan processing, and hence the scan processing for the fBS is restricted.

As described above, according to the embodiment, it is not necessary to contain information on an fBS in the neighbor BS advertisement message advertised from each mBS. Therefore, it is possible to prevent occurrence of such a situation that while a given mBS has a large number of neighboring fBSs, the neighbor BS advertisement message of the given mBS cannot contain information on all the neighbor fBSs. Further, by avoiding advertising information on a neighbor fBS, it becomes possible to use the network bandwidth efficiently.

On the other hand, presence of an fBS neighboring the SBS is detected when the location information provided from the SBS satisfies the location condition registered in the default neighbor BS information table 28. With this, even if the mBS does not advertise information on an fBS, the mobile terminal 1 can handle the fBS neighboring the SBS as a scan target, and also determine, as the TBS, an fBS available for the mobile terminal 1 according to the status of movement of the mobile terminal 1.

Further, because the mBS does not advertise information on fBSs as the neighbor BS information, it is possible to exclude fBSs, which are unavailable for the mobile terminal 1, from the neighbor BSs which are recognized by the mobile terminal 1 for the SBS. Accordingly, there never occurs a case where the mobile terminal 1 tries handover to an unavailable fBS, and the handover is refused. Therefore, it is possible to carry out seamless handover from the mBS to the fBS.

As described above, in a mobile communication network system according to the embodiment, the mBSs, which are public base stations, are defined as the first base station group, for which information is advertised, whereas the fBSs, which are local base stations, are defined as the second base station group, for which information is not advertised. The mobile terminal 1 holds information on a second base station available for the mobile terminal 1, that is to say an fBS, together with the location condition for including the second base station (fBS) as a scan target. In a case where the location information of the SBS satisfies the location condition, the second base station that satisfies the location condition is detected as the scan target.

With this, the problem described above can be solved. Specifically, neighbor base station information, which is advertised (broadcast) with respect to air (space) by a base station, can be limited to base stations belonging to the first base station group. With this, it is possible to reduce the amount of information on neighbor base stations to be advertised. Therefore, a limited wireless bandwidth can be used more for transmission of user data. In other words, efficient use of the bandwidth can be achieved.

Further, the mobile terminal does not receive information on a local base station (femto base station) that the mobile terminal does not need to access, and hence waste of wireless bandwidth and memory provided to the mobile terminal can be prevented. Further, it is possible to prevent carrying out unnecessary scan or handover with respect to a femto base station which the mobile terminal is not allowed to access. Due to this, power saving operation and an extended communication time can be achieved.

Here, in the second embodiment, description has been given of the mobile communication network system, that is, the WiMAX system as a wireless communication system. It should be noted that the configuration described in the second embodiment is applicable to other wireless communication systems in which public base stations and local base stations coexist, such as a cellular phone network system and a wireless LAN system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal used in a wireless communication system including a first base station group for which base station information is advertised to the mobile terminal and a second base station group for which the base station information is not advertised to the mobile terminal, each base station belonging to the first base station group permitting each mobile terminal to access, each base station belonging to the second base station group permitting only specified mobile terminals to access, the mobile terminal comprising:
a reception unit to receive location information, and
a detection unit to execute base station detection processing with respect to the first base station group and the second base station group when the received location information is associated with a specified base station which permits the mobile terminal to access and belongs to the second base station group, and to execute the base station detection processing with respect to the first base station group while restricting the base station detection processing with respect to the second base station group when the location information is not associated with the specified base station.

2. The mobile terminal according to claim 1, wherein the location information contains location information of the mobile terminal, which is acquired from a currently-connected base station belonging to the first base station group or the second base station group.

3. The mobile terminal according to claim 1, wherein the location information contains location information of one or more base stations, which is acquired from a currently-connected base station belonging to the first base station group or the second base station group.

4. The mobile terminal according to claim 1, wherein the location information contains location information of the mobile terminal, which is acquired from a GPS satellite.

5. A base station detection method for a mobile terminal, the mobile terminal being used in a wireless communication system including a first base station group for which base station information is advertised to the mobile terminal and a second base station group for which the base station information is not advertised to the mobile terminal, each base station belonging to the first base station group permitting each mobile terminal to access, each base station belonging to the second base station group permitting only specified mobile terminals to access, the method comprising:
receiving location information,
executing base station detection processing with respect to the first base station group and the second base station group when the received location information is associated with a specified base station which permits the mobile terminal to access and belongs to the second base station group; and
executing the base station detection processing with respect to the first base station group while restricting the base station detection processing with respect to the second base station group when the location information is not associated with the specified base station.

6. The base station detection method for a mobile terminal according to claim 5, wherein the location information contains location information of the mobile terminal, which is acquired from a currently-connected base station belonging to the first base station group or the second base station group.

7. The base station detection method for a mobile terminal according to claim 5, wherein the location information contains location information of one or more base stations, which is acquired from a currently-connected base station belonging to the first base station group or the second base station group.

8. The base station detection method for a mobile terminal according to claim 5, wherein the location information contains location information of the mobile terminal, which is acquired from a GPS satellite.

9. A wireless communication system, comprising:
a first base station group for which information is advertised to a mobile terminal, each base station belonging to the first base station group permitting each mobile terminal to access;
a second base station group for which information is not advertised to the mobile terminal, each base station belonging to the second base station group permitting only specified mobile terminals to access; and
the mobile terminal being permitted to access each base station belonging to the first base station group and a specified base station which permits the mobile terminal to access and belongs to the second base station group,
the mobile terminal including:
a reception unit to receive location information; and
a detection unit to execute base station detection processing with respect to the first base station group and the second base station group when the received location information is associated with the specified base station in the second base station group, and to execute the base station detection processing with respect to the first base station group while restricting the base station detection processing with respect to the second base station group when the location information is not associated with the specified base station.
